(19) United States
(12) Patent Application Publication
(10) Pub. No.: US 2014/0004487 A1
(43) Pub. Date: Jan. 2, 2014

(54) Immersive Training Environment

(71) Applicants: Joseph M. Cheben, Boerne, TX (US); Dennis Cafiero, Irvine, CA (US)

(72) Inventors: Joseph M. Cheben, Boerne, TX (US); Dennis Cafiero, Irvine, CA (US)

(21) Appl. No.: 14/001,362

(22) PCT Filed: Mar. 12, 2012
(86) PCT No.: PCT/US12/28789

§ 371 Date: Aug. 23, 2013

Related U.S. Application Data
(60) Provisional application No. 61/467,851, filed on Mar. 25, 2011.
(60) Provisional application No. 61/514,769, filed on Aug. 3, 2011.

(51) Int. Cl. G09B 5/00

(52) U.S. Cl. CPC G09B 5/00
USPC 434/219

(57) ABSTRACT

A real-time immersive training system is provided. The system includes an immersive visualization room that includes a rendering device configured to provide a three dimensional image of a workspace on a display surface, an operations console configured to provide plant information to the rendering device and obtain operator input from an input device, and a communications system configured to interact with a plant simulator. An operator console includes a control display and input system designed to simulate a plant control board for the workspace. A dynamic process simulator is configured to run a process simulation of the workspace, provide simulated real time data of the workspace to the immersive visualization room and the operator console, accept control inputs from the operator console, and interaction data from the immersive visualization room. An instructor system is configured to interact with the dynamic process simulator, the operator console, or the immersive visualization room, or any combinations thereof, and is configured to activate simulations of events.

### CROSS-REFERENCE TO RELATED APPLICATION

This application claims priority from both U.S. Provisional Patent Application No. 61/467,851, filed on Mar. 25, 2011, entitled APPARATUS AND SYSTEMS FOR THREE DIMENSIONAL IMMERSIVE TRAINING AND METHODS RELATED THERETO and U.S. Provisional Patent Application No. 61/514,769, filed on Aug. 3, 2011, entitled IMMERSIVE TRAINING ENVIRONMENT, both of which are incorporated by reference herein in their entirety.

### FIELD

The present techniques relate to apparatus and systems for training. More particularly, the disclosure is related to an immersive environment for training plant operators.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Hydrocarbon usage is a fundamental aspect of current civilization. Facilities for the production, processing, transportation, and use of hydrocarbons continue to be built in locations around the world. The efficiency of these plants become increasingly important, as even issues can add to cost or create issues for regulatory agencies.

Training of operators for these facilities can be challenging, as training classes may not engage the operators sufficiently for knowledge retention. Further, training on the active process may be expensive, as an experience operator is often required to continuously monitor the trainee during the training. Training on the actual process may also lead to process upsets, as inexperienced personnel may activate the wrong controls or at the wrong time.

Virtual reality (VR) simulations are available for training These simulations provide a training environment that can allow an employee to move about in a virtual plant environment and make changes to the plant environment. However, the simulations do not provide a subjective reality, often merely providing a flat screen environment, through which an operator can move an avatar, or other representation, using a mouse. In some VR simulations, an operator may wear a VR headset, which can provide a stereoscopic view of the plant environment, however, this may not provide a realistic feel of the physical environment, as the visual space may not be in high resolution, and may not include a visualization of the operator.

Accordingly, new training technologies are needed that accurately reflect the real environment that a trainee is functioning within. These environments should allow an operator to actually see their interactions with the physical environment of the plant.

### SUMMARY

An embodiment provides a real-time immersive training system. The system includes an immersive visualization room. The immersive visualization room includes a rendering device that is configured to provide a three dimensional image of a workspace on a display surface and an operations console that is configured to provide plant information to the rendering device and obtain operator input from an input device. The immersive visualization room also includes a communications system that is configured to interact with a dynamic process simulator, retrieve plant information for the operations console, and pass operator input back to the dynamic process simulator. The system includes an operator console that includes a control board designed to simulate a plant control board for the workspace. The dynamic process simulator is configured to run a process simulation of the workspace, provide simulated real time data of the workspace to the immersive visualization room and the operator console, accept control inputs from the operator console, and interaction data from the immersive visualization room. An instructor system includes a system configured to interact with the dynamic process simulator, the operator console, or the immersive visualization room, or any combinations thereof. The instructor system is configured to activate simulations of events.

Another embodiment provides a real-time immersive training system that includes a number of immersive visualization rooms. An immersive visualization room includes a display configured to provide a three dimensional image of a workspace, and an input system configured to obtain data representing an interaction with the workspace. In this embodiment, a multi-user server is configured to allow interactions between each of the immersive visualization rooms, wherein trainees in each of the immersive visualization rooms can see representations of trainees in other immersive visualization rooms. The real-time immersive training system includes an operator console that includes a control board designed to simulate a plant control board for the workspace. A dynamic process simulator is configured to run a process simulation of the workspace and provide simulated real time data of the workspace to each of the plurality of immersive visualization rooms and the operator console. The dynamic process simulator is configured to accept control inputs from the operator console, and accept interaction data from each of the immersive visualization rooms. The real-time immersive training system includes an instructor system that is configured to interact with the dynamic process simulator, the operator console, or the immersive visualization rooms, or any combinations thereof, wherein the instructor system is configured to activate simulations of events.

Another embodiment provides a method for training workers for a hydrocarbon environment. The method includes placing a field trainee in a real time immersive environment, wherein the real time immersive environment is configured to provide three dimensional images of a workspace to the field trainee, and to accept inputs from the field trainee that represent interactions of the trainee with the environment. An operator trainee is placed at an operations console configured to provide the operator trainee with simulated data representing the workspace. A dynamic process simulator is configured to provide simulated real time data to the field trainee and the operator trainee based, at least in part, on a model of a workplace. A trainer is placed at a training console that is configured to provide control input to the dynamic process simulator to trigger simulations of events, and the trainer is allowed to guide the field trainee and operator trainee through the events.

Yet another embodiment provides an immersive visualization room, that includes a rendering device configured to provide a three dimensional image of a workspace on a display surface. The immersive visualization room includes an operations console configured to provide plant information to the rendering device and obtain operator input from an input device. A communications device in the immersive visualization room is configured to interact with a plant simulator, retrieve plant information for the operations console, and pass the operator input to the plant simulator.

### DESCRIPTION OF THE DRAWINGS

The advantages of the present techniques are better understood by referring to the following detailed description and the attached drawings, in which:

FIG. 1 is a block diagram of an immersive training system in which an immersive visualization room is coupled to a dynamic process simulator;

FIG. 2 is a block diagram of an immersive training system in which a second immersive visualization room is coupled to the dynamic process simulator;

FIG. 3 is a block diagram of an immersive training system showing different functional units that can work together in an embodiment;

FIG. 4 is a block diagram of an immersive training system that integrates the functionality of the instructor room into a dynamic process simulator (DPS);

FIG. 5 is a block diagram of a method for initializing an immersive training system;

FIG. 6 is a block diagram of a method for interacting with an outside operator in an immersive training system;

FIG. 7 is a block diagram of a method for interacting with an inside operator in an immersive training system; and

FIG. 8 is a block diagram of a method for interacting with a trainer in an immersive training system.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As used herein, a “Facility” is a tangible piece of physical equipment through which hydrocarbon fluids are produced from a reservoir, injected into a reservoir, processed, or transported. In its broadest sense, the term facility is applied to any equipment that may be present along the flow path between a reservoir and its delivery outlets. Facilities may comprise production wells, injection wells, well tubulars, wellhead equipment, gathering lines, manifolds, pumps, compressors, separators, surface flow lines, steam generation plants, processing plants, and delivery outlets. Examples of facilities include LNG plants, LNG tanker vessels, and regasification plants.

A “hydrocarbon” is an organic compound that primarily includes the elements hydrogen and carbon, although nitrogen, sulphur, oxygen, metals, or any number of other elements may be present in small amounts. As used herein, hydrocarbons generally refer to components found in natural gas, oil, or chemical processing facilities.

As used herein, the term “natural gas” refers to a multi-component gas obtained from a crude oil well (associated gas) and/or from a subterranean gas-bearing formation (non-associated gas). The composition and pressure of natural gas can vary significantly. A typical natural gas stream contains methane (CH₄) as a major component, i.e. greater than 50 mol % of the natural gas stream is methane. The natural gas stream can also contain ethane (C₂H₆), higher molecular weight hydrocarbons (e.g., C₃-C₂₀ hydrocarbons), one or more acid gases (e.g., hydrogen sulfide), or any combination thereof. The natural gas can also contain minor amounts of contaminants such as water, nitrogen, iron sulfide, wax, crude oil, or any combination thereof.

“Substantial” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

Overview

Apparatus and methods are provided herein for an immersive training system that used real-time three-dimensional (3D) graphics and operator interactions. These features allow an outside operator to manipulate valves, press buttons, and the like, as if located in the actual plant environment. Further, both an inside operator of a control board and an outside operator can work together to control the simulation, in which each sees the responses in the simulation that they may see in the actual environment (e.g., a visual indication is displayed or presented as part of the simulation). The inside operator and outside operator can be in radio communications as if they were in the real plant environment. The responses are generated by a dynamic process simulation model of the process.

The training session can be monitored and controlled by an instructor who also interfaces with the dynamic process simulator. The instructor can trigger events in real-time via this console, to increase the difficulty level and randomness of the training session.

The system may be expanded to include multiple outside operators in 3D environments in communication with multiple inside operators. Further, the system may be interfaced to other simulation environments, such as ship simulators, to provide a complete training experience for operators and crew. The apparatus and systems make a realistic 3D environment that can make individuals feel as if they are in their actual work environment. This realism makes the training more effective and better equips personnel to perform their jobs quickly and effectively. The simulation is also physically realistic, e.g., using collision detection and avoidance so the trainees cannot navigate through virtual objects. In one or more embodiments, the 3D models are photo-realistic to further enhance the apparent reality.

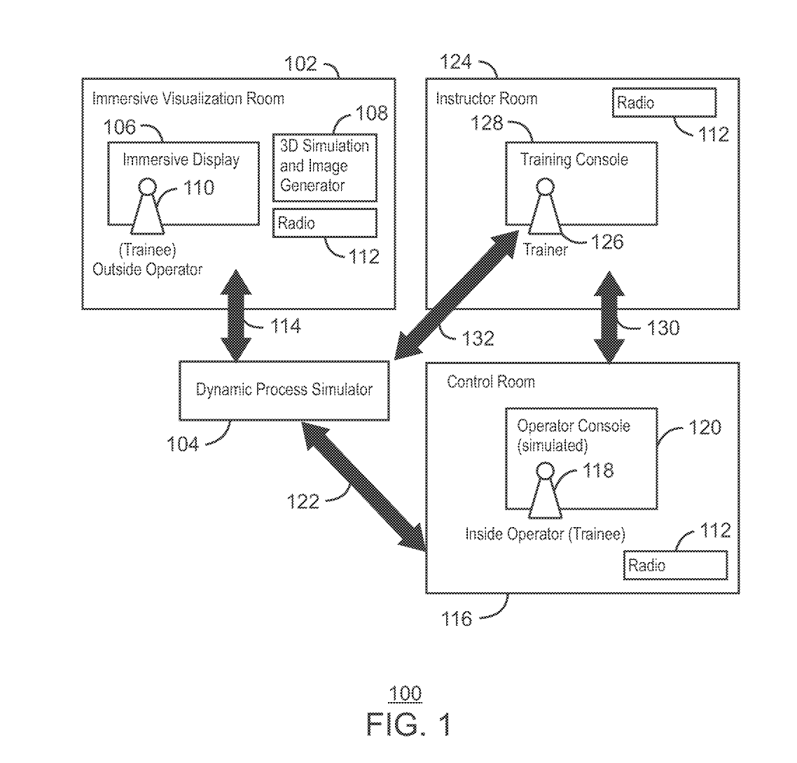

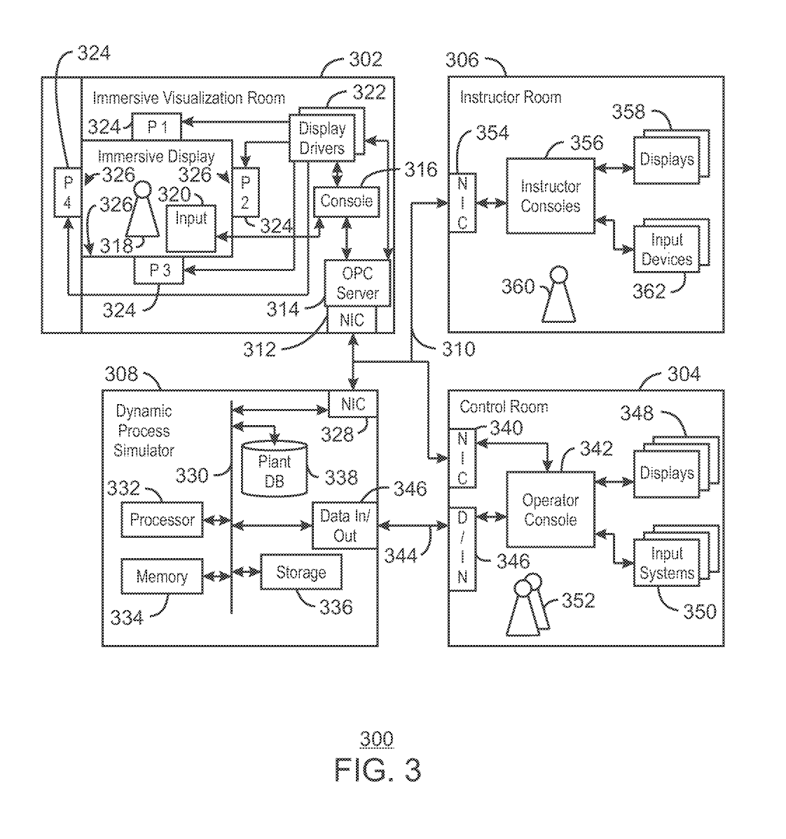

FIG. 1 is a block diagram of an immersive training system 100 in which an immersive visualization room 102 is coupled to a dynamic process simulator 104. In an embodiment, the immersive visualization room 102 is an ICube display available from EON Reality of Irvine, Calif., USA. The immersive visualization room 102 provides an immersive display 106 in which a surfaces, such as walls, floor, or ceiling, display a three dimensional image of the workspace, e.g., an offshore platform, a tanker, a chemical plant, a LNG plant, a LNG tanker, a refinery, and the like. In some embodiments, all six walls of an immersive visualization room 102 display the workspace, providing a complete immersion. The immersive visualization room 102 can include any number of other types of simulation rooms, such as rooms that project displays onto a curved or convex surfaces or a dome. A 3D simulation and image generator 108 generates the display of the workspace, and accepts input from an outside operator 110. The 3D simulation and image generator 108 can include any number of separate systems to obtain data and inputs, and generate the displayed images, as discussed further with respect to FIG. 3. A radio 112, or other devices, may be used to communicate with other personnel during the simulation.

The immersive visualization room 102 communicates with the dynamic process simulator 104 to exchange process parameters 114, which are used to create and adjust the images for the immersive display 106. Such process parameters include valve positions, plant instrument readings, vessel temperatures, vessel pressures, and other information, such as plant vessel conditions, leaks, and the like.

The dynamic process simulator 104 models the dynamic processes of the workspace and, thus, can provide the same response as a real workspace. The feedback and reactions of the simulated dynamic process may then be translated back to the virtual 3D world, resulting in status lamps lighting, valves moving, alarms sounding, and the like. Training and operating environments may be made more realistic by adding plant sounds, vibration, smells, and visual effects, such as alarms, machinery noise, and gas smells, among others. Effects may also be utilized to simulate walking, climbing ladders, turning valves, and the like. Further, the output from the dynamic process simulator 104 can be translated into scaled visual entities and elements in the images of the immersive display 106, such as mapping scalar values to valve positions, mapping scalar values to dial positions, and mapping scalar values to numeric digits on virtual displays, among others. Binary or Boolean values may also be mapped, for example, to open/close states on switches and valves, and to neutral and depressed states on buttons, among others. Boolean values may also be mapped to sounds in the environment, such as providing a hissing sound if a leak is indicated.

Process parameters can be provided to the dynamic process simulator 104 from the 3D simulation and image generator 108, allowing the outside operator 110 to affect changes in the environment, such as opening or closing valves, turning equipment on or off, and the like. The process parameters 114 allow the display to reflect the actual responses that the operators may see in the environment.

In an embodiment, a level-of-detail metric is used to limit the process parameters 114 being updated to those that are within the view of the outside operator 110. This may increase the speed of the simulation and, thus, the appearance of reality, as it may take a significant amount of time to update all of the process parameters 114 in a large plant.

In addition to the immersive visualization room 102, the immersive training system 100 has a control room 116 in which an inside operator 118 operates an operator console 120. The operator console 120 simulates a plant control board, allowing the inside operator 118 to control valves, motors, and the like, and to monitor plant readings such as vessel pressures, temperatures, levels, and the like. A radio 112, or other device, can be used by the inside operator 118 to communicate with the outside operator 110, and other personnel.

The operator console 120 functions by exchanging inside display parameters 122 with the dynamic process simulator 104. To further increase the reality of the simulation, the inside display parameters 122 may be signals provided to a DCS controller by a digital/analog simulation of the plant running on the dynamic process simulator 104. This can allow the inside operator 118 to gain experience with a control console 120 that matches the type used in the real plant environment.

The immersive training system 100 can be controlled from an instructor room 124 in which a trainer 126 monitors one or more training consoles 128. The instructor room 124 does not have to be separate from the control room 116, but may be part of the control room 116, for example, if the trainer 126 were on an elevated platform overseeing the operations in the control room 116 and immersive visualization room 102. If the instructor room 124 is separate from the other rooms, the trainer 126 may use a radio 112, or other device, to communicate with the inside operator 118 and outside operator 110.

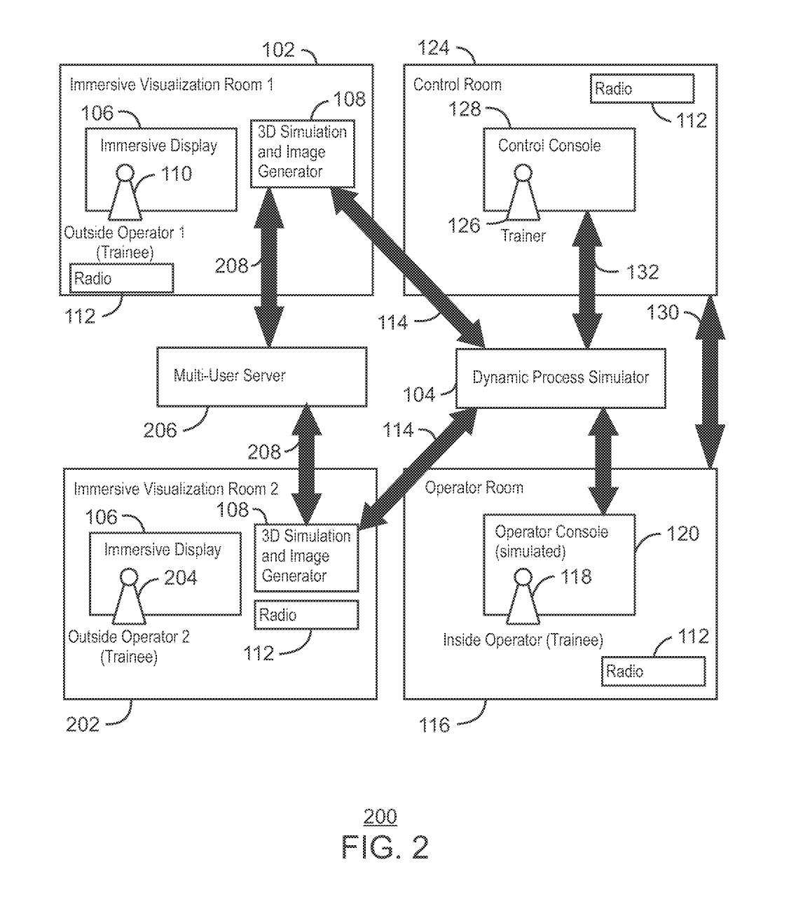

The training consoles 128 can exchange information 130 with the operator consoles 120, for example, allowing the trainer 126 to see a screen or make an adjustment to a control. Other functions may also be performed by the training consoles 128, such as exchanging control information 132 directly with the dynamic process simulator 104, allowing the trainer 126 to insert conditions and events directly into the plant environment. The immersive training system 100 is not limited to the number of rooms or systems shown, but may be used to link any number of immersive visualization rooms 102 together to form a multiuser environment, as discussed with respect to FIG. 2.

### Multiple Operator Immersive Training System

FIG. 2 is a block diagram of an immersive training system 200 in which a second immersive visualization room 202 is coupled to the dynamic process simulator 104. Like numbers are as described with respect to FIG. 1. A second outside operator 204 can interact with the second immersive visualization room 202 in a similar manner to the first outside operator 110. A multi-user server 206 exchanges information 208 with each of the immersive visualization rooms 102 and 202. The information 208 keeps tracks of users logging in an out of the system and manages the plant elements when multiple users are interacting with elements simultaneously. The multi-user server 206 can also track an image, or avatar, of each of the outside operators 110 and 204 that may be rendered in the other operator's immersive visualization room 202 and 102, so that each operator can see the other when they are in the other operator's field-of-view. This tracking of the session data for each outside operator 110 and 204 by the multi-user server 206 ensures that movements and control in one visualization room 102 or 202 are correctly rendered in the other visualization room 202 or 102.

The immersive visualization rooms 102 and 202 may be proximate to each other or may be located in distant rooms that are linked through a wide area network. Similarly, the trainer 126 and inside operator 118 may be in other geographic locations. For example, such linkages can allow a trainer 126 in Houston, Tex., to interact with an inside operator 118 in Anchorage, Alaska, and outside operators 110 and 204 in Qatar. As described before, the second outside operator 204 can communicate with other personnel using a radio 112, or other device. In the case of remotely located personnel, a communications link that simulates a radio over a network may be used.

FIG. 3 is a block diagram of an immersive training system 300 showing different functional units that can work together in an embodiment. The layout of the immersive training system 300 generally matches the arrangement of FIG. 1. As described above, an immersive visualization room 302, an inside operator room 304, and an instructor room 306 can communicate with a dynamic process simulator 308 over a network 310, such as an local area network, a wide area network, or a virtual private network (VPN) hosted across the internet. The network 310 may an Ethernet network, a proprietary plant network, or any other networking protocol.

The immersive visualization room 302 can include a number of systems that allow the immersive visualization room 302 to function as a modular unit that may be used in concert with any number of process simulators. In the immersive visualization room 302, a network interface card (NIC) 312 can couple to the network 310. The NIC 312 is part of a computer system, such as an Open Process Control (OPC) server 314, which functions as an application programming interface (API) to obtain process parameters for the immersive visualization room 302 from the dynamic process simulator 308.

Another computer system may function as the console 316 for the immersive visualization room 302. The console 316 keeps track of the location of the outside operator 318 in the environment and the operator's position relative to equipment. Using the location information, the console 316 can obtain input from the outside operator 318, for example, using an input device 320. In some embodiments, the console 316 may have a NIC 312 and operate to directly obtain tag information, or process parameters, for example, without using the OPC server 314.

The input device 320 can include any number of devices, such as a handheld controller used for video games. In an embodiment, the input device 320 can include a laser pointer and camera tracking system to identify the point being selected. In an embodiment, a gyroscopic presentation controller may be used as an input device. In an embodiment, the outside operator 318 may wear gloves and other equipment that has tracking spots affixed to the outside. In this embodiment, the input device 320 can use a light source and a camera to track the motion of the outside operator 318 and interpret the motions to identify command inputs. The input device 320 may include a camera and motion analysis system to interpret motions without further equipment or illumination. The input device 320 can include a treadmill or ball type enclosure to allow realistic movements to control simulated motion. Voice commands may be used with a voice recognition system, for example, saying a phrase such as “select valve,” or the like.

The input device 320 can be used to select devices and enter parameters, such as turning on or off a device, rotating a valve, opening an instrument control panel, moving through the simulated environment, and the like. Any changes to parameter values may then be passed to the OPC server 314 to be transmitted to the dynamic process simulator 308.

The console 316 can hold a computer aided design (CAD) model of the environment, which can be used to build the visual model of the plant that is displayed to the outside operator 318. To perform this function, the console 316 uses the CAD model to communicate equipment views to a series of rendering computers, such as display drivers 322, each of which may render a different perspective view of the current location. Each of the display drivers 322 may drive a visualization device 324, which can provide the view for various surfaces 326 of the immersive display. The visualization devices 324 can include single units for each wall 326, such as a projector, a video display, and the like. In some embodiments, multiple units may be used for a visualization device 324. In these embodiments, a bank or cluster of video displays may be used for a surface 326. It can be understood that each of the console 316, rendering computers 322, and OPC server 314 may contain multi-core processors or be part of a cluster computing system, to provide the rendering power to make the immersive display operate in a smooth fashion.

The dynamic process simulator (DPS) 308 provides parameter updates to and accepts parameter inputs from the immersive visualization room 302, for example, through the OPC server 314. To perform this function, the DPS 308 is linked to the network 310, for example, by a network interface card (NIC) 328. The NIC 328 is linked to a bus 330, which allows communications and control by a processor 332. The processor 332 may be a single core processor, a multi-core processor, or a computing cluster. The processor 332 can access code stored in a memory 334 to perform the functions described herein. The memory 334 may include any combination of random access memory (RAM), read only memory (ROM), flash memory, and the like. A storage system 336 can be used to store code for the functions described herein, as well as for the operating system, communications, and the like. In some embodiments, the dynamic process simulator 308 may function as a central server, providing the functional code and rendering information to all of the other units 302, 304, and 306.

A plant database 338 can contain the plant parameters, for example, in a relational database format. The plant database 338 may be stored in the storage system 336 or may be in a separate storage system. Code modules can be configured to direct the processor 332 of the DPS 308 to adjust output parameters based on input parameters, time, flows, compositions, and the like, i.e., to function as a process simulator. The output parameters can then be provided to the other units 302, 304, and 306 for display. In some embodiments, this may be performed automatically, based on a previously determined location or screen. In other embodiments, the other units 302, 304, and 306 may track their own location or screens, requesting values from the DPS 308 when needed.

The control room 304 may communicate process parameters in a number of different ways. A NIC 340 may place the control room 304 in communication with the DPS 308 over the network 310, allowing the operator console 342 to access and set parameter information as digital values, such as in OPC format or directly into registers on a DCS.

In some embodiments, the operator console 342 may be a functional distributed control system (DCS) with its own consoles. In this embodiment, the operator console 342 may communicate with the DPS 302 through analog and binary links 344. Plant equipment interfaces 346, such as analog-to-digital convertors, digital-to-analog convertors, binary inputs, and binary outputs may be used at each end of the links 344. The DPS 308 can then function as a simulation of a plant, providing simulated analog values to the DCS.

The operator console 342 provides display information to screen displays 348 and accepts input from input devices 350, such as keyboards, mice, trackballs, and the like. Thus, an inside operator 352 can select a screen, which triggers the operator console 342 to build the graphics, access the relevant parameters from the dynamic process simulator 308, and display the screen on the displays 348.

The instructor room 306 can also tie into the network 310 using a network interface card 354. An instructor console 356 can display information about the system on one or more displays 358. The trainer 360 can use input devices 362 to access information or enter commands. For example, through the network 310, the instructor consoles 356 can be used to access screens from the operator consoles 342, change settings through the operator consoles 342, view screen shots from the immersive visualization room 303, or directly modify parameters in the plant database 338 of the dynamic process simulator.

Additional systems could be added to the network 310, as described with respect to FIG. 2. These systems could include more immersive visualization rooms, more control rooms or consoles, and more instructor rooms. In an embodiment, for example, a ship simulator may be tied to the system to provide a comprehensive simulation of an LNG tanker. The immersive training system 300 is not limited to the configuration shown above. In other embodiments, some of the functionality may be more integrated, which may lower the total cost of the immersive training system 300.

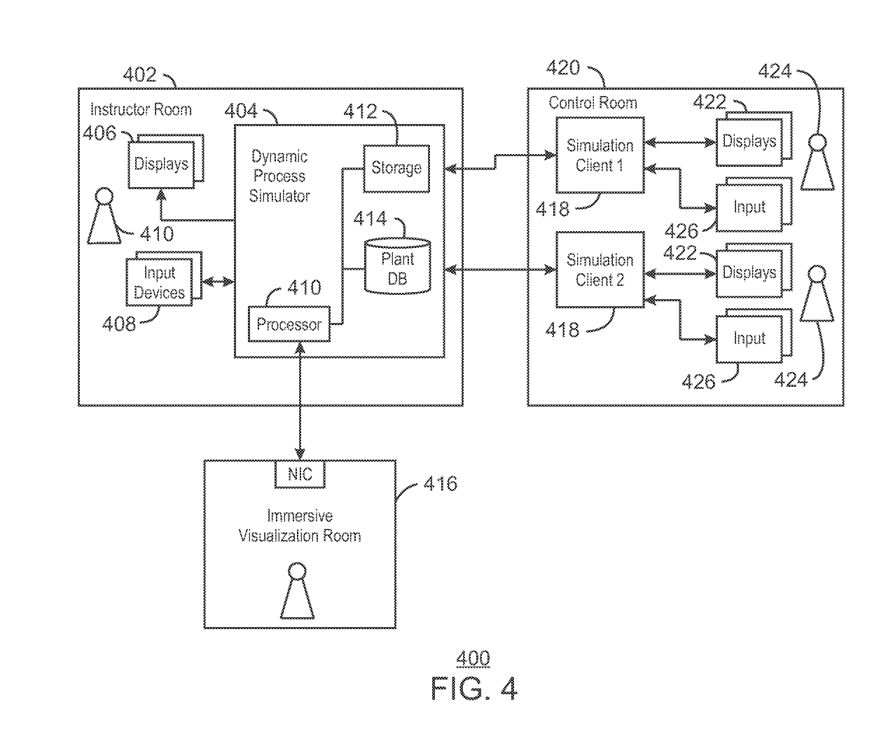

FIG. 4 is a block diagram of an immersive training system 400 that integrates the functionality of the instructor room 402 with a dynamic process simulator (DPS) 404. In this arrangement, the DPS 404 provides the displays 406 and input devices 408 for the trainer 410, giving the trainer 410 direct control of the DPS 404. The DPS 404 has a processor 410 that can access code in a storage system 412 to provide the functionality. The code is configured to direct the processor 410 to access parameters in a plant database 414 and change other parameters based on the parameters accessed, e.g., to provide a process simulation. The code can also direct the processor 410 to access parameters in the plant database 414 and provide those parameters to other systems, such as an immersive visualization room 416. The immersive visualization room 416 functions as described with respect to the previous figures.

In this embodiment, the DPS 404 acts as a server for two simulator clients 418 in a control room 420. The simulator clients 418 render information for displays 422 and accept input from inside operators 424 through input devices 426. However, the simulator clients 418 may not be full operator consoles in this embodiment and may merely display screens and information sent from the DPS 404.

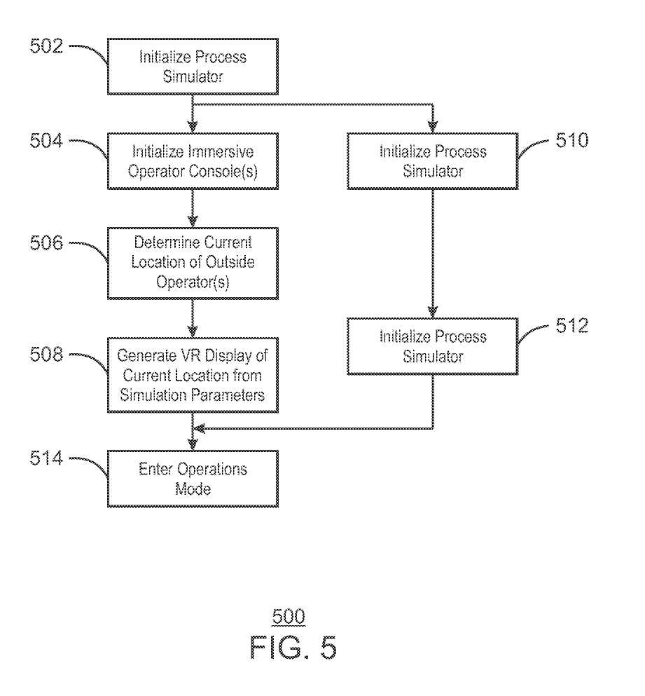

Various methods can be used for interacting with the immersive training system described herein, as discussed with respect to FIGS. 5-8. It can be understood that the immersive training system is not limited to these methods or functions, as any number of further functions can be performed by the various parts of the system. Further, the methods discussed below are not to be considered all-inclusive. Other actions may be performed in addition to or instead of the actions listed. The methods are to be considered representative methods that can be used for explanatory purposes.

FIG. 5 is a block diagram of a method 500 for initializing an immersive training system. The method 500 begins at block 502 with the initialization of the dynamic process simulator. Any number of starting conditions may be used, depending on the training sequence desired. For example, the initial condition loaded may have parameters that correspond to the plant being in a pre-startup (empty) condition. In an embodiment, a set of initial variables are loaded in the plant database that correspond to a normal operating condition. After parameter initialization, the dynamic process simulator starts an updating loop that monitors input parameters and changes output parameters accordingly, i.e., the process simulation. At this point, the dynamic process simulator is ready to provide parameters to the other systems. The remaining systems may be initialized in parallel.

At block 504, the initialization of the immersive visualization room (or rooms) may be started, for example, by initializing a console and an OPC, or other API, server. The initialization may include loading plant models and relevant parameter lists from a storage system. At block 506, an initial location is determined for the outside operator. In an embodiment, this location is at an entry to the plant. In another embodiment, the location is the last location before a shutdown. At block 508, the OPC server obtains the parameters for objects in view of the current location and provides these parameters to the console. The console generates the objects and parameter linkages for the current view and provides these to the rendering computers, which generate the display of the current location.

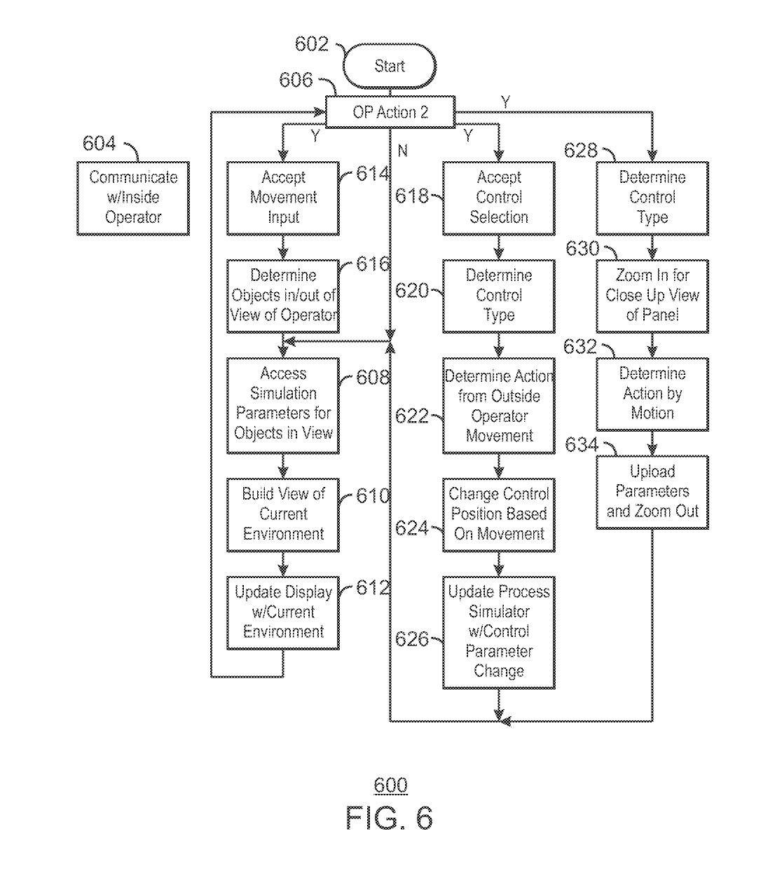

Parallel to the initiation of the immersive visualization room, at block 510, the operator consoles are initialized. These include both the inside operator consoles and the instructor console. The initialization includes determining a start-up screen for the initialization, among others. In an embodiment, the start-up screen is a plant overview screen that allows selection of any of the other process screens. In other embodiments, the start-up screen is the last screen that was accessed before a shutdown. The current parameters for the start-up screen are accessed from the dynamic process simulator. At block 512, the start-up screen is built and displayed on each of the operator consoles. At block 514, the immersive training system enters an operations mode. In operations mode, each of the systems loops through an input/updating cycle, as discussed further with respect to FIGS. 6-8, below.

FIG. 6 is a block diagram of a method 600 for interacting with an outside operator in an immersive training system. The method 600 starts at block 602 after the initialization of the immersive training system is finished at block 514 of FIG. 5. The method 600 for interacting with the outside operator can follow any number of paths, depending on the action selected by the outside operator. At any time, at block 604, the outside operator may communicate with the inside operator, trainer, or other personnel using a radio or other device.

Referring also to FIG. 3, at block 606, the immersive training system determines if the outside operator has provided an input, for example, using an input device 320 coupled to a console 316 in an immersive visualization room 302. If, at block 606, no input has been provided, the immersive training system performs a screen update. During the screen update, at block 608, the immersive visualization room accesses simulation parameters from a dynamic process simulator for objects in view of the operator. For example, the immersive visualization room may use a level-of-detail parameter to determine how much information to access for objects that are progressively farther from the outside operator location. At block 610, a current view of the environment is constructed, for example, by a console that associates the parameters to the graphical elements. At block 612, the current view is passed to rendering computers that generate the views used for each of the walls and the images on the walls are updated. Process flow then returns to block 606 to check for outside operator input. The screen update and input loop can occur on a time span that can be short enough that the outside operator perceives smooth motion, for example, every 10 milliseconds (ms), every 25 ms, or every 50 ms. It may be clear that as the timeframe gets longer the risk of motion discontinuities leading to a break in the reality of the scene may increase.

If the immersive visualization room detects an input corresponding to operator motion at block 606, process flow proceeds to block 614. At block 614, the immersive visualization room accepts input that corresponds to an operator motion. The input may be provided by any number of suitable devices, as discussed with respect to block 320. The input may include turning in place, moving, climbing up a stair or ladder, climbing down a stair or ladder, rotating a view to look up or down, or any number of other motions or combinations of motions. The motions may be combined to form an automated sequence. For example, the outside operator may indicate a desire to climb up a ladder and the console completes the motion and exits the ladder on the next floor. During the motion, at block 616, the console of the immersive visualization room may determine what objects are currently within the view of the operator. Objects may come into view as they are approached or are no longer hidden behind other objects. Similarly, objects may be hidden or pass out of view as they are left behind.

Determining which objects are in view prior to obtaining parameters for those objects within view may increase the speed at which the immersive visualization room updates the screens, increasing the apparent reality. However, the immersive visualization room is not limited to obtaining parameters for only the objects in view and may obtain parameters for all objects in the plant simulation. For smaller simulations, this may decrease the overhead of the calculation without affecting the reality of the simulation.

After block 616, process control continues at block 608 to perform a screen update, as described above. During automated moves, such as climbing a ladder, going down a staircase, and the like, outside operator inputs may be automatically created to continue the movement until complete. After the screen update is finished at block 612, process flow returns to block 606 to check for further operator inputs.

If at block 606, the console detects an input selecting a control, process flow proceeds to block 618. The selection may be performed by using a handheld controller to place a cursor on the control, by determining that the operator has placed a hand in proximity to the control, or using any number of other methods. At block 618, the identity of the control accessed is determined For example, an outside operator may place a hand proximate to a manual valve, triggering a selection of the valve at block 618. At block 620, the console of the immersive visualization room determines the type of control, e.g., manual valve, automatic valve, electrical switch, or manual locks (for lock-out/tag-out operations), among many others. At block 622, the console determines the action for the control from the control type and operator motion. For example, if the outside operator rotates the hand that is selecting the valve, the valve may open or close in proportion to the hand movement. This same motion may be translated to other types of controllers, for example, if an operator makes a circular motion with a handheld controller, a joystick, or any other type of control device, the valve may be turned a proportional amount. At block 624, the control position may be changed based on the movement of the valve. At block 626, the dynamic process simulator is updated with the new control position, for example, using the OPC server 314. From block 626, flow proceeds to block 608 to update the screen with the new process parameters. After the screen update is finished at block 612, process flow returns to block 606 to check for further operator inputs.

For a control that takes some time to move in the real world, such as a manual valve, intermediate updating of the parameter and display may be performed to increase the reality of the simulation. For example, closing a valve on a line that currently has a liquid flow may slow or divert an increasing amount of the liquid, increasing the upstream pressure. Closing the valve too quickly may lead to a rupture in a vessel feeding the liquid flow, while closing the valve slowly may work without problems. Thus, for increased realism, the valve movement may not be a binary action. In other cases, such as turning on a switch to activate a pump, the action may be binary, and completed prior to updating the dynamic process server and screens.

Any number of other actions may be included in the possible operator actions for the immersive visualization room. For example, if the immersive visualization room determines at block 606 that the outside operator has selected a more complex object, such as an instrument panel, or other object that needs to be examined more closely, flow proceeds to block 628. At block 628, the control type is determined and possible actions for that control are identified. For example at block 630, a close up view of the controls is displayed, for example, as an expanded illustration on a surface of the immersive display. For an instrument inside a control box, the box can be shown as opened to display the controls. At block 632, an action for the instrument panel is determined based on an outside operator input. For example, the outside operator may select a particular sub-control within the box and adjust a set point. The actions may depend on the instrument type, allowing any number of field instruments and controls to be manipulated. At block 634, the outside operator indicates that the display is no longer needed. At that point, the parameters are uploaded to the dynamic process simulator and the display is zoomed back out. Process flow then proceeds to block 608 to update the displays in the immersive visualization room. After the screen update is finished at block 612, process flow returns to block 606 to check for further operator inputs.

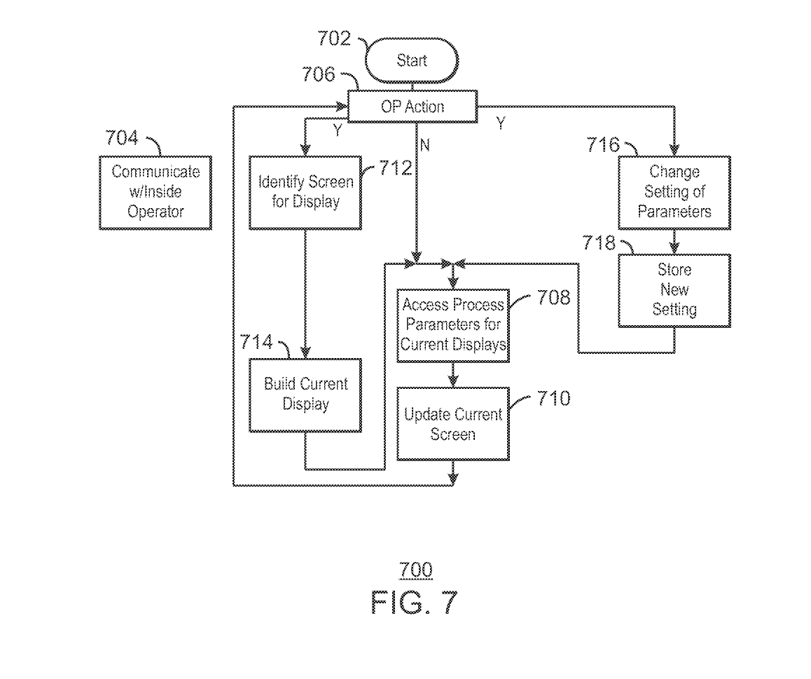

FIG. 7 is a block diagram of a method 700 for interacting with an inside operator in an immersive training system. The method 700 begins at block 702 after initialization of the immersive training system is complete at block 514 of FIG. 5. At any time during the method 700, at block 704, the inside operator can communicate with the outside operator, the trainer, or other personnel, for example, using a radio or simulated radio. Referring also to FIG. 3, at block 706, an operator console 342 may determine if an inside operator has provided an input. In the immersive training system 400 of FIG. 4, this function may be performed by a simulator client 418. If no inside operator action is detected at block 706, process flow proceeds to block 708. At block 708, process parameters for the current display screens are obtained from the dynamic process simulator. These parameters are used at block 710 to update the current display screens. In the immersive training system 400 of FIG. 4, the functions of blocks 708 and 710 may be directly performed by the dynamic process simulator 402. After the screen update is completed at block 710, process flow can then return to block 706 to check for an inside operator action.

The actions at blocks 708 and 710 may be considered the basic screen update loop. In a DCS environment, this may take place every 5 seconds, every 10 seconds, every 15 seconds, or longer. Further, different parameters may be updated in different time sequences, for example, with some parameters updating every second and others updating every 15 seconds. This can be based on the time constant of the response of the parameters involved.

If, at block 706, it is determined that an inside operator has selected a different screen for display, process flow proceeds to block 712. At block 712, the screen selected for display is identified. The identity of the screen selected may be performed by selecting a next screen or previous screen button, by selecting the screen from a catalog or index of screens, by selecting the end of a flow line, by selecting a process vessel, and the like. Once the identity of the new screen is selected, the graphic of the equipment on the screen is built and the screen is displayed. Process flow then proceeds to block 708 for updating the screens, as described above. After the screen update is completed at block 710, process flow can then return to block 706 to check for an inside operator action.

If, at block 706, it is determined that an inside operator has changed a setting or parameter, process flow proceeds to block 716. At block 716, the new value for the process parameter is entered. At block 718, the new value is passed to the dynamic process simulator for storage in the plant database. Process flow then proceeds to block 708 to update the screens. After the screen update is completed at block 710, process flow can then return to block 706 to check for an inside operator action.

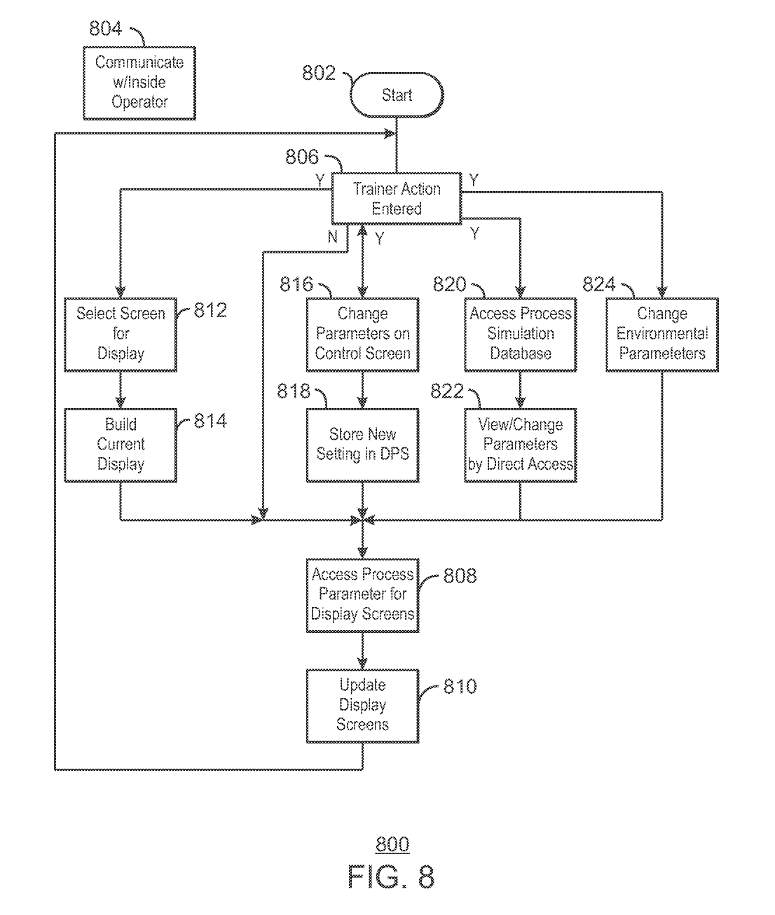

FIG. 8 is a block diagram of a method 800 for interacting with a trainer in an immersive training system. The method 800 begins at block 802 after initialization of the immersive training system is complete at block 514 of FIG. 5. At any time during the method 800, at block 804, the trainer can communicate with the outside operator, the inside operator, or other personnel, for example, using a radio or simulated radio. Referring also to FIG. 3, at block 806, an instructor console 356 may determine if a trainer has provided an input. In the immersive training system 400 of FIG. 4, this function may be performed directly by the dynamic process simulator 404. If no inside operator action is detected at block 806, process flow proceeds to block 808. At block 808, process parameters for the current display screens are obtained from the dynamic process simulator. These parameters are used at block 810 to update the current display screens. In the immersive training system 400 of FIG. 4, the functions of blocks 808 and 810 may be directly performed by the dynamic process simulator 402. Process flow can then return to block 806 to check for an inside operator action.

The actions in blocks 808 and 810 may be considered the basic screen update. In a DCS environment, this may take place every 5 seconds, every 10 seconds, every 15 seconds, or longer. Further, different parameters may be updated in different time sequences, for example, with some parameters updating every second and others updating every 15 seconds. This can be based on the time constant of the response of the parameters involved.

If, at block 806, it is determined that a trainer has selected a different screen for display, process flow proceeds to block 812. At block 812, the screen selected for display is identified. The identity of the screen selected may be performed by selecting a next screen or previous screen button, by selecting the screen from a catalog or index of screens, by selecting the end of a flow line, by selecting a process vessel, and the like. In an embodiment, the screen selected is identified by the selection of an inside operator in a control room. Once the identity of the new screen is selected, the graphic of the equipment on the screen is built and the screen is displayed. Process flow then proceeds to block 808 for updating the screens, as described above. After the screen update is completed at block 810, process flow can then return to block 806 to check for an inside operator action.

If, at block 806, it is determined that a trainer has changed a setting or parameter, process flow proceeds to block 816. At block 816, the new value for the process parameter is entered. At block 818, the new value is passed to the dynamic process simulator for storage in the plant database. Process flow then proceeds to block 808 to update the screens. After the screen update is completed at block 810, process flow can then return to block 806 to check for an inside operator action.

The trainer has settings available that cannot be directly seen or modified by the operators. For example, if, at block 806, the trainer indicates that direct access to the plant database and process simulation is desired, flow proceeds to block 820. At block 820, the trainer is provided with a display screen showing plant process parameters in the plant database, and providing direct access to the parameter values. At block 822, the trainer is allowed to make direct changes to parameter values. Such changes may include changing reaction rates or other process simulation information in addition to such values as temperature, pressure, and level, among others. Process flow then proceeds to block 808 for screen updating. The trainer may also have access to environmental variables, as indicated at block 824. Such variables may include ambient temperature, wind speed, insolation, and the like. Process flow then proceeds to block 808 for updating the screens, as described above. After the screen update is completed at block 810, process flow can then return to block 806 to check for an inside operator action.

While the present techniques may be susceptible to various modifications and alternative forms, the embodiments discussed above have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

Exemplary Embodiments

An exemplary embodiment described herein includes a real-time immersive training system. The real-time immersive training system can include an immersive visualization room. The immersive visualization room includes a rendering device that is configured to provide a three dimensional image of a workspace on a display surface and an operations console that is configured to provide plant information to the rendering device and obtain operator input from an input device. The immersive visualization room can also include a communications system that is configured to interact with a dynamic process simulator, retrieve plant information for the operations console, and pass operator input back to the dynamic process simulator. The real-time immersive training system can include an operator console that includes a control board designed to simulate a plant control board for the workspace. The dynamic process simulator is configured to run (e.g., execute on a processor) a process simulation of the workspace, provide simulated real time data of the workspace to the immersive visualization room and the operator console, accept control inputs from the operator console, and interaction data from the immersive visualization room. An instructor system includes a system configured to interact with the dynamic process simulator, the operator console, or the immersive visualization room, or any combinations thereof. The instructor system is configured to activate simulations of events. A display surface used in the immersive visualization room may include the surfaces of a square room, a convex surface, a domed surface, or any combinations thereof.

The real-time immersive training system can include other immersive visualization rooms that are configured to interact with the dynamic process simulator, the operator console, and the instructor system. A multi-user server may be configured to allow interaction of the immersive visualization rooms, so that a trainee in one immersive visualization room can see a representation of a trainee in another immersive visualization room.

The workspace may include a liquefied natural gas (LNG) plant, an offshore platform, a chemical plant, a tanker, an LNG tanker, or any combinations thereof. The events that are simulated may include standard operations, emergency operations, or any combinations thereof.

A communication system may be included to let users and trainers communicate as if they were in the workspace. The input system may include a detection system configured to analyze gestures, motions, or combinations thereof to obtain the data representing the interaction with the workspace. A treadmill may be configured to allow a user to input motion data to the workspace.

The real-time immersive training system may include a three dimensional computer aided drafting (CAD) model of the workspace.

A distributed control system (DCS) may be included and configured to interact with the dynamic process simulator, provide operational data to the operator console, and accept inputs from the operator console.

The simulated real time data can include simulated pressure measurements, simulated temperature measurements, simulated flow measurements, simulated level measurements, or any combinations thereof. The simulated real time data can include simulated images of an event determined from the dynamic process simulation.

The real-time immersive training system can include a bridge simulator for a ship configured to interact with the immersive visualization room, the operator console, the dynamic process simulator, or the instructor system, or any combinations thereof.

Another exemplary embodiment described herein provides a real-time immersive training system that includes a number of immersive visualization rooms. An immersive visualization room includes a display configured to provide a three dimensional image of a workspace, and an input system configured to obtain data representing an interaction with the workspace. In this embodiment, a multi-user server is configured to allow interactions between each of the immersive visualization rooms, wherein trainees in each of the immersive visualization rooms can see representations of trainees in other immersive visualization rooms. The real-time immersive training system includes an operator console that includes a control board designed to simulate a plant control board for the workspace. A dynamic process simulator is configured to run a process simulation of the workspace and provide simulated real time data of the workspace to each of the plurality of immersive visualization rooms and the operator console. The dynamic process simulator is configured to accept control inputs from the operator console, and accept interaction data from each of the immersive visualization rooms. The real-time immersive training system includes an instructor system that is configured to interact with the dynamic process simulator, the operator console, or the immersive visualization rooms, or any combinations thereof, wherein the instructor system is configured to activate simulations of events.

The real-time immersive training system can include a workspace radio system configured to allow communications between a plurality of trainers, a plurality of trainees, a plant operator, or any combinations thereof.

Another exemplary embodiment described herein provides a method for training workers for a hydrocarbon environment. The method includes placing a field trainee in a real time immersive environment, wherein the real time immersive environment is configured to provide three dimensional images of a workspace to the field trainee, and to accept inputs from the field trainee that represent interactions of the trainee with the environment. An operator trainee is placed at an operations console configured to provide the operator trainee with simulated data representing the workspace. A dynamic process simulator is configured to provide simulated real time data to the field trainee and the operator trainee based, at least in part, on a model of a workplace. A trainer is placed at a training console that is configured to provide control input to the dynamic process simulator to trigger simulations of events, and the trainer is allowed to guide the field trainee and operator trainee through the events.

The method can include providing a ship simulator configured to interact with the dynamic process simulator and simulating events in marine operations.

The method can include providing simulated image data of the events to the real time immersive environment for display to the field trainee.

The method can include placing a plurality of field trainees in individual real time immersive environments, and allowing the plurality of field trainees to interact with each other, the operator trainee, a trainer, the workspace, or any combinations thereof.

The method can include analyzing motions made by the field trainee to determine data representing interaction with the workspace.

Yet another exemplary embodiment described herein provides an immersive visualization room, that includes a rendering device configured to provide a three dimensional image of a workspace on a display surface. The immersive visualization room includes an operations console configured to provide plant information to the rendering device and obtain operator input from an input device. A communications device in the immersive visualization room is configured to interact with a plant simulator, retrieve plant information for the operations console, and pass the operator input to the plant simulator.

The communications device used in the immersive visualization room can include an Open Process Control (OPC) server.

In these embodiments above, run may refer to the execution of a set of instructions on a processor to perform various functions. Also, real-time may mean a task, process or response occurs substantially immediately. That is, real-time is taken to mean generation of data at a rate that is useful or adequate for making decisions during or concurrent with the simulation processes for interaction with a user or operator. One non-limiting example includes information that is collected and provided at a rate that is adequate to aid in appropriately communicating and displaying it for interaction in a simulation. Accordingly, it includes dataflow that occurs without any delay added beyond the minimum required for generation of the dataflow components

What is claimed is:

1. A real-time immersive training system, comprising:
an immersive visualization room, comprising:
a rendering device configured to provide a three dimensional image of a workspace on a display surface;
an operations console configured to:
provide plant information to the rendering device; and
obtain operator input from an input device; and
a communications system configured to:
interact with a dynamic process simulator;
retrieve plant information for the operations console; and
pass operator input back to the dynamic process simulator;
an operator console, comprising a control board designed to simulate a plant control board for the workspace;
the dynamic process simulator configured to:
run a process simulation of the workspace;
provide simulated real time data of the workspace to the immersive visualization room and the operator console;
accept control inputs from the operator console; and
interaction data from the immersive visualization room; and
an instructor system, comprising a system configured to interact with the dynamic process simulator, the operator console, or the immersive visualization room, or any combinations thereof, and wherein the instructor system is configured to activate simulations of events.

2. The real-time immersive training system of claim 1, wherein the workspace comprises a liquefied natural gas (LNG) plant, an off-shore platform, a chemical plant, a tanker, an LNG tanker, or any combinations thereof.

3. The real-time immersive training system of claim 1, comprising at least one other immersive visualization room, wherein the at least one other immersive visualization room is configured to interact with the dynamic process simulator, the operator console, and the instructor system.

4. The real-time immersive training system of claim 3, comprising a multi-user server configured to allow interaction of the immersive visualization room and the at least one other immersive visualization room, wherein a trainee in the immersive visualization room can see a representation of a trainee in another immersive visualization room.

5. The real-time immersive training system of claim 1, wherein the display surface comprises surfaces of a square room, a convex surface, a domed surface, or any combinations thereof.

6. The real-time immersive training system of claim 1, wherein the events comprise standard operations, emergency operations, or any combinations thereof.

7. The real-time immersive training system of claim 1, comprising a communication system, configured to let users and trainers communicate as if they were in the workspace.

8. The real-time immersive training system of claim 1, wherein the input system comprises a detection system configured to analyze gestures, motions, or combinations thereof to obtain the data representing the interaction with the workspace.

9. The real-time immersive training system of claim 1, comprising a treadmill configured to allow a user to input motion data to the workspace.

10. The real-time immersive training system of claim 1, comprising a three dimensional computer aided drafting (CAD) model of the workspace.

11. The real-time immersive training system of claim 1, comprising a distributed control system (DCS) configured to:
interact with the dynamic process simulator;
provide operational data to the operator console; and
accept inputs from the operator console.

12. The real-time immersive training system of claim 1, wherein the simulated real time data comprises simulated pressure measurements, simulated temperature measurements, simulated flow measurements, simulated level measurements, or any combinations thereof.

13. The real-time immersive training system of claim 1, wherein the simulated real time data comprises simulated images of an event determined from the dynamic process simulation.

14. The real-time immersive training system of claim 1, comprising a bridge simulator for a ship configured to interact with the immersive visualization room, the operator console, the dynamic process simulator, or the instructor system, or any combinations thereof.

15. A real-time immersive training system, comprising:
a plurality of immersive visualization rooms, wherein an immersive visualization room comprises a display configured to provide a three dimensional image of a workspace, and an input system configured to obtain data representing an interaction with the workspace;
a multi-user server configured to allow interactions between each of the plurality of immersive visualization rooms, wherein trainees in each of the plurality of immersive visualization rooms can see representations of trainees in other immersive visualization rooms;
an operator console, comprising a control board designed to simulate a plant control board for the workspace;
a dynamic process simulator configured to:
run a process simulation of the workspace;
provide simulated real time data of the workspace to each of the plurality of immersive visualization rooms and the operator console;
accept control inputs from the operator console; and
interaction data from each of the plurality of immersive visualization rooms; and
an instructor system, comprising a system configured to interact with the dynamic process simulator, the operator console, or the plurality of immersive visualization rooms, or any combinations thereof, and wherein the instructor system is configured to activate simulations of events.

16. The real-time immersive training system of claim 15, comprising a workspace radio system configured to allow communications between a plurality of trainers, a plurality of trainees, a plant operator, or any combinations thereof.

17. A method for training workers for a hydrocarbon environment, comprising:
placing a field trainee in a real time immersive environment, wherein the real time immersive environment is configured to provide three dimensional images of a workspace to the field trainee, and to accept inputs from the field trainee that represent interactions of the trainee with the environment;
placing an operator trainee at an operations console configured to provide the operator trainee with simulated data representing the workspace;
providing a dynamic process simulator configured to provide simulated real time data to the field trainee and the operator trainee based, at least in part, on a model of a workplace; and
placing a trainer at a training console configured to provide control input to the dynamic process simulator to trigger simulations of events, and allowing the trainer to guide the field trainee and operator trainee through the events.

18. The method of claim 17, comprising:
providing a ship simulator configured to interact with the dynamic process simulator and the real time immersive environment; and
simulating events in marine operations.

19. The method of claim 17, comprising providing simulated image data of the events to the real time immersive environment for display to the field trainee.

20. The method of claim 17, comprising placing a plurality of field trainees in individual real time immersive environments, and allowing the plurality of field trainees to interact with each other, the operator trainee, a trainer, the workspace, or any combinations thereof.

21. The method of claim 17, comprising analyzing motions made by the field trainee to determine data representing interaction with the workspace.

22. (canceled)

23. (canceled)
